(19) United States
(12) Patent Application Publication
(10) Pub. No.: US 2005/0061144 A1
(43) Pub. Date: Mar. 24, 2005

(54) Actuator

(76) Inventor: Gerald Schall, Bobenheim-Roxheim (DE)

Correspondence Address: BorgWarner Inc;Powertrain Technical Center, Patent Department Suite 100, 3800 Automation Avenue, Auburn Hills, MI, 48326-1782, US

(21) Appl. No.: 10/478,783

(22) PCT Filed: May 23, 2001
(86) PCT No.: PCT/EP01/05946

(51) Int. Cl. F16J 3/00

(52) U.S. Cl. 92/98 D

(57) ABSTRACT

The actuator includes a membrane (5) which, when at rest, rests partially against a rest surface (14) of a membrane plate (16), which membrane plate is displaceable in a housing (1). Pressure can be applied to one side of the membrane. Upon application of pressure, the membrane (5) increasingly leaves the rest surface (14) and increasingly comes to lie against a deposit surface (40) provided on the inside of the housing. As the membrane moves, it moves an actuator element (25). The rest surface (14) includes at least one segment (45) which widens viewed in the movement direction (B), while the deposit surface (40) includes at least one segment (41) which narrows viewed in the movement direction (B).

### BACKGROUND OF THE INVENTION

1. Field of the Invention

The invention concerns an actuator having a housing and a membrane. In the invention concerns in particular a pneumatic or hydraulic activated actuator which is useful, for example, for mechanical regulation or control.

2. Description of the Related Art

In this type of regulation or control it is often desired to produce the actual control force by means of action of a pressure medium and to transmit this to the actual control or regulating means via an actuator element. For this purpose a membrane can be provided, which can be acted upon with significant pressure—depending upon the situation of use, for example, up to 6 bar. The pressure can be brought to bear upon the membrane via a suitable pressure medium, for example pneumatic, or by means of a liquid, for example hydraulic oil.

In the rest position—which is understood to mean that there is no application of pressure, or insufficient application of pressure for achieving movement—the membrane assumes a rest position and could in this case rest against a rest surface. Upon action of pressure the membrane executes a movement within the housing of the actuator element and thereby rolls partially off of the resting surface. The membrane movement is transmitted to the actuator element. When the application of pressure is withdrawn, a spring causes a resetting or return of the membrane.

### SUMMARY OF THE INVENTION

With this as background, it is the task of the present invention to provide an actuator, which even under conditions of frequent driving, that is, with many operating or load cycles in a short period of time, is characterized by a very constant, problem-free and reliable drive behavior, and maintains this drive behavior even in difficult external conditions.

This task is inventively solved by a drive device having a housing and membrane,
wherein the membrane can be acted upon on one side by pressure,
wherein the membrane, when at rest, rests partially against a rest surface of a membrane plate which is displaceable in the housing,
wherein the membrane is moveable in a movement direction upon application of pressure and thereby increasingly travels away from the rest surface, increasingly lies against a deposit surface provided on the inner side of the housing, and drives an actuator element,
wherein the rest surface includes at least one segment which widens when viewed in the movement direction, and
the deposit surface includes at least one segment, which narrows viewed in the movement direction.

An essential aspect of the invention resides, on the one hand, in the provision of a rest surface on the membrane plate and, on the other hand, a deposit surface for deposit of the membrane which rolls off of the membrane plate upon activation (that is, upon being impacted by pressure), wherein the rest surface and the deposit surface extend at least segment-wise not concentrically nor parallel, but rather, at least segment-wise, widen or, as the case may be, narrow. Therewith the rest surface and the deposit surface, or the widening and narrowing segments, run in opposition in the movement direction and at an acute angle towards each other. This makes possible a very even rolling-off and seating of the membrane during application of pressure or, as the case may be, during subsequent pressure withdrawal. Superior deformation conditions are thereby achieved for the membrane, which result among other things in continuity and a reduced drumming action. It is particularly advantageous that by this measure, at least along a movement segment, a constant free roll-off or peel-off length of the membrane can be achieved.

The construction elements necessary therefore can be easily produced without additional expense in that, for example, the membrane plate or, as the case may be, the corresponding housing segment with the widening or, as the case may be, the corresponding narrowing, is produced with the widening or, as the case may be, the narrowing, during the manufacturing process—for example by deep drawing.

An advantageous embodiment of the invention envisions, that the rest surface conically widens, viewed in the movement direction. Therewith particularly good roll-off or peel-off conditions for the membrane can be achieved. Besides this, a conical widening, for example by deep drawing in the case of a metallic membrane plate, is easily realized in manufacturing technology.

Based on the same considerations, a design of the inventive actuator is preferred in which the deposit surface conically narrows, seen in the movement direction.

In accordance with an advantageous further development of the inventive actuator it is envisioned that the rest surface widens with an angle, which is the same angle as that with which the deposit surface narrows. Therewith a particularly even movement of the membrane and a particularly good or suitable roll-off length or peel-off length can be realized.

In the case of employment under difficult environmental conditions a design of the invention has been found to be suitable, in which the actuator element slides in a guide bushing under oscillation dampening, which guide bushing for its part is mounted in the housing via a O-ring. Preferably, the guide bushing is self-lubricating.

### BRIEF DESCRIPTION OF THE DRAWING

Illustrative embodiments of the invention are described in the following on the basis of the figures, which show:

FIG. 1 a first illustrative embodiment of an inventive actuator in longitudinal section,

FIGS. 2 and 3 individual components of the actuator according to FIG. 1 in longitudinal section, and

FIG. 4 a second embodiment of an inventive actuator in longitudinal section.

### DETAILED DESCRIPTION OF THE INVENTION

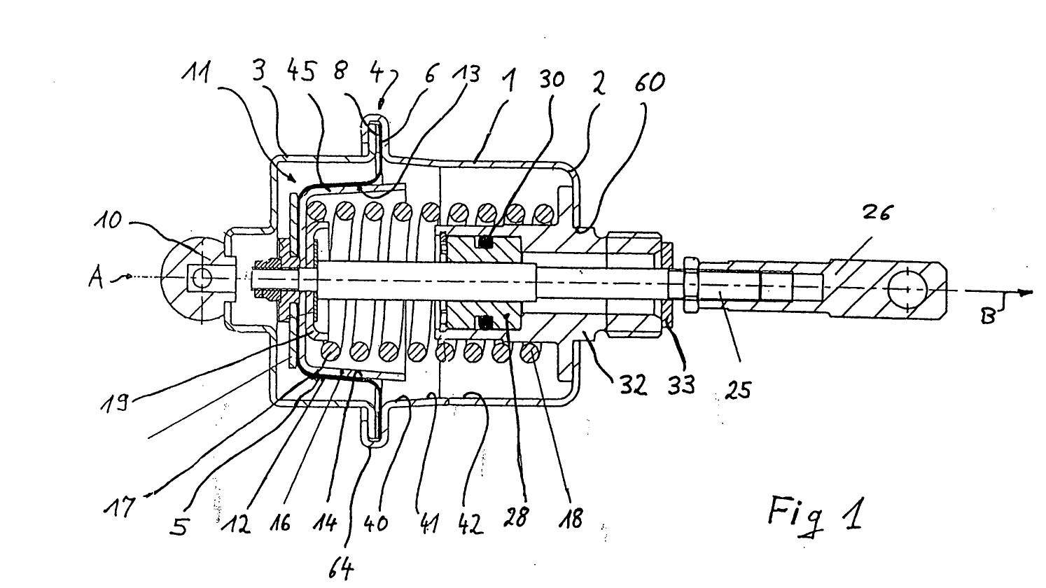

FIG. 1 shows a actuator with a housing 1, which is comprised of a first housing part 2 and a second, complimentary housing part 2. In the joining or interface area 4 between the housing parts 2, 3 a first flexible membrane 5 is provided and fixed along its perimetry 6. Suitable membranes include for example a membrane distributed under the mark RECIFLEX. For sealing, a sealing ring 8 is provided between the housing part 3 and the membrane peripheral area 6. The housing part 3 has on its end, viewed in axial direction A, a coupling piece 10. Via the coupling piece 10 a pressure medium (for example compressed air or hydraulic fluid) can be introduced into the pressure tight internal space 11, which is formed between the lower part 12 of the membrane 5 and the housing part 3.

In the rest position—that is, without pressure actuation or with only slight pre-tensioning pressure—the membrane assume the rest position shown in FIG. 1. Thereby the major part of the inner membrane surface 13 lies against the outer side of membrane plate 16. The outside of the membrane plate therewith forms a deposit surface referred to as rest surface 14 for the inner membrane surface 13. The membrane plate is acted upon by one end 17 of a mechanical return element in the form of a helical spring 18, which is supported against the base or bottom inner side of the membrane plate 16. The helical spring 18 is centered by a plate 19, and forces the membrane plate 16 into the shown rest position.

An actuator element in the form of a control rod 25 is connected with the membrane plate 16. On the free end of the control rod 25 a guide piece 26 is provided, to which, for example, a not shown regulator or control mechanism is connected and can be operated. The control rod 25 slides or is guided in a guide bushing 28, which for its part is connected with the housing, or casing 32, via an interposed O-ring 30. Thereby—even in the case of high frequency operation—a good oscillation dampening is realized, so that the occurrence of disturbing vibrations cannot have any adverse consequences upon the either actuator or the means connected to the guide piece 26. In the area where the control rod 25 exits out of the housing 1 a disk 33 is provided as splash plate.

Upon application of pressure the internal pressure in the space 11 increases via the pressure medium. This space expands, in that the membrane 5 moves along the longitudinal axis A in the movement direction B towards the right against the spring force of the helical spring 18. With “movement direction B” that direction is being referred to in which the membrane and therewith the control rod 25 move upon application of pressure.

Thereby also the control rod 25 connected rigidly with the membrane plate 16 is moved to the right and is guided through the guide bushing 28. Therewith the actuator device functions as actuator and realizes a desired position or control movement of the guide piece. During this movement, a part of that inner membrane surface 13 rolls off or peels off, which at first lies against the rest surface 14 of the membrane plate 16, and continues to roll off of this rest surface. Upon further movement the membrane inverts or turns inside out, so that increasingly a part of the inner membrane surface 13 lies against a deposit surface 40. This deposit surface 40 is formed by a segment 41 of the inner side 42 of the housing 2.

The rest surface 14 of the membrane plate 16 exhibits—viewed in movement direction B—at least one widening segment 45. This is shaped as a conical widening. From the manufacturing perspective this is easily achieved, in that the membrane plate 16, formed for example as a metal deep-draw part, is appropriate conically deep-drawn.

The deposit surface 40 formed in the housing part 2 narrows viewed in the movement direction B. During the process of movement this produces an increasingly smaller gap between the rest surface 14 of the membrane plate 16 on the one hand, and the deposit surface on the other hand. Thereby particularly advantageous roll off and roll on conditions are produced for the membrane and therewith an optimal guided rolling process. This results in a very even roll movement of the membrane and an evenness and reduced drumming action.

As the pressure action is reduced or completely withdrawn, the membrane plate and therewith also the membrane and the control rod 25 are again moved back towards the left to, as the case may be, the starting or rest position. Therewith also the described geometry of the corresponding roll-on or, as the case may be, roll-off surfaces, cause a very even roll movement of the membrane.

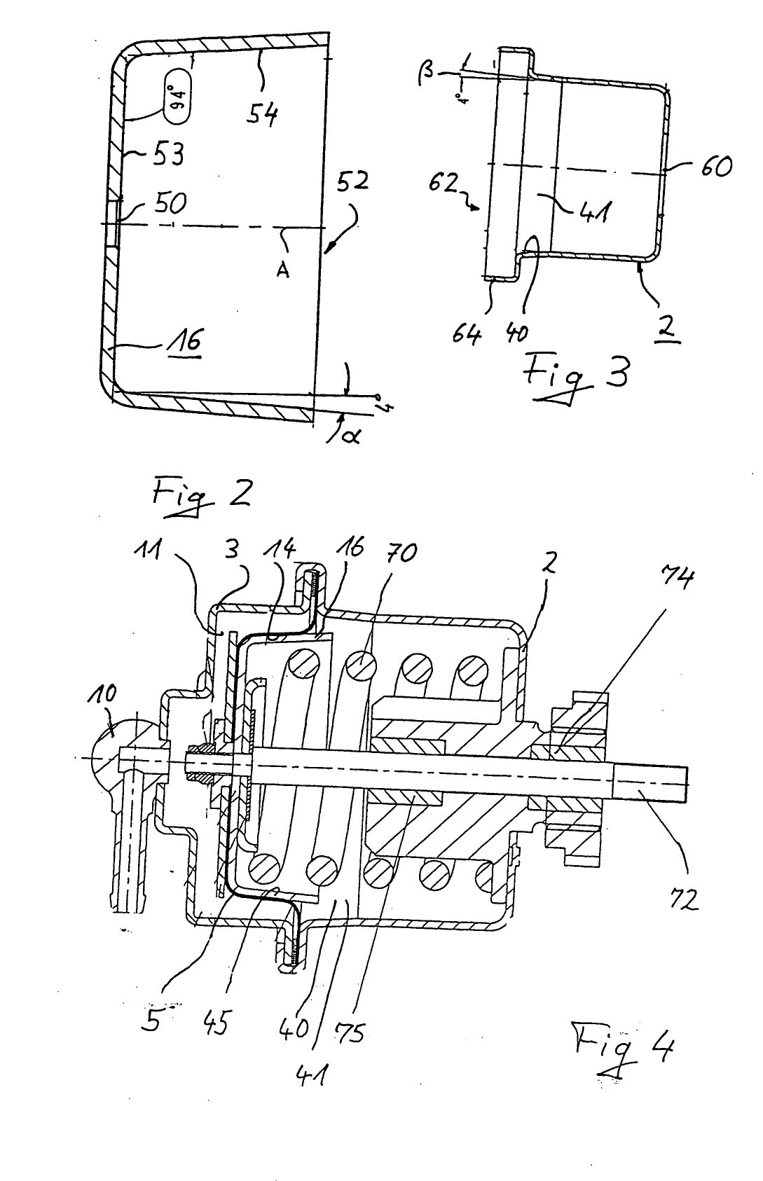

FIG. 2 shows, strongly exaggerated, the membrane plate 16 according to FIG. 1; FIG. 3 shows the housing part 2.

The membrane plate 16 (FIG. 2) is shaped like a cap and has, in the base of the plate 53, a borehole for fixing the control rod 25 (FIG. 1). Towards the opening 52 the membrane plate 16 widens conically, and preferably, in accordance with a preferred embodiment, at an angle α=40 with respect to the longitudinal axis A. Therewith there results between the base of the plate 53 and the sidewall 54 an angle of 94°.

FIG. 3 shows the associated corresponding design of the housing part 2. In a bore 60 there is fixed, as shown in FIG. 1, a casing 32. An opening 62 ends with a collar 64, which after assembly is bent over and, as shown in FIG. 1, serves for connecting with the housing part 3 and fixing of the membrane 5. From the collar 64 a segment 41 narrows along the deposit surface 40 towards the bore 60. The narrowing angle β of the preferred conically designed narrowing is dimensioned corresponding to the widening angle α (FIG. 2) at β=4°. Therewith the cooperating segments 41, 45 of the housing part 2 or as the case may be the membrane plate 16 exhibit the same angles or inclinations, which makes possible an even roll off movement.

FIG. 4 shows an embodiment of an inventive actuator in longitudinal section corresponding essentially to the design of FIG. 1. For simplification the elements which correspond to each other are indicated with the same reference numbers as the elements in FIG. 1. The actuator according to FIG. 4 is overall somewhat more compact and it exhibits a helical spring 70 with tighter thread count.

A control rod 72 is mounted in two guide bushings 74 and 75, preferably self-lubricating. Otherwise, the functional principle described in detail in association with FIG. 1 applies here, and in particular housing part 2 exhibits a narrowing segment 41 with a deposit surface 40. The membrane plate 16 has a corresponding widening rest surface 14.

1-6. (cancelled)

7. An apparatus comprising:
an actuator;
a housing (1); and
a membrane (5),
wherein said membrane (5) can be acted upon on one side by a pressure, wherein when said membrane (5) is at rest, said membrane (5) rests partially against a rest surface (14) of a membrane plate (16), wherein said membrane plate (16) is displaceable in said housing (1),
wherein said membrane (5) is moveable in a movement direction (B) upon application of said pressure, and thereupon said membrane (5) increasingly leaves said rest surface (14) and increasingly comes to lie against a deposit surface (40),
wherein said deposit surface (40) is provided on the inside of the housing (1), and thereby said membrane (5) drives an actuator element (25),
wherein said rest surface (14) includes at least one segment (45) that widens when viewed in the movement direction (B), and
wherein said deposit surface (40) includes at least one segment (41) that narrows when viewed in the movement direction (B).

8. The apparatus according to claim 7, wherein said rest surface (14) conically widens when viewed in the movement direction (B).

9. The apparatus according claim 7, wherein said deposit surface (40) conically narrows when viewed in the movement direction (B).

10. The apparatus according to claim 7, wherein said rest surface (14) widens with an angle (α) which is the same as that angle (β) with which the deposit surface (40) narrows.

11. The apparatus according to claim 7, wherein said actuator element (25) is guided oscillation dampened in a guide bushing (28), wherein said guide bushing (28) is mounted in said housing (1) via an O-ring (30).

12. The apparatus according to claim 11, wherein said guide bushing (28) is self-lubricating.
